(19) United States
(12) Patent Application Publication
(10) Pub. No.: US 2007/0090657 A1
(43) Pub. Date: Apr. 26, 2007

(54) Door lock and method for manufacturing said door lock

(76) Inventor: Nils-Gunnar Jaktlund, Linkoping (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/556,675

(22) PCT Filed: May 14, 2004
(86) PCT No.: PCT/SE04/00745

§ 371 Date: Nov. 24, 2006

(30) Foreign Application Priority Data
May 20, 2003 (SE) 0301469-3

(51) Int. Cl. E05B 15/02

(52) U.S. Cl. 292/340

(57) ABSTRACT

The present invention concerns a door lock for locking a door (2) to an underlying structure (3). A machine element (6) disposed in connection to a through opening in the underlying structure (3) is arranged so as to engage a bolt (4) that is insertable into a through opening in the door (2). The door lock is characterized in that the machine element (6) is inserted through the opening in the underlying structure (3) to a position at which the openings in the door (2) and the underlying structure (3) form, together with the part of the machine element (6) that extends outside of the underlying structure (6) [sic], a length that is longer than the bolt length, while at the same time an internal thread on the machine element extends sufficiently far through the underlying structure that, with the joint mounted, it engages the bolt to create the joint. The invention also concerns a method for manufacturing the door lock as per the foregoing.

### TECHNICAL AREA

This invention concerns a door lock for locking a door to an underlying structure in accordance with the preamble to claim 1.

The invention also concerns a method for manufacturing a door lock according to the preamble to claim 3.

### STATE OF THE ART

The manufacture of complex structures such as airplanes requires access to a large number of components. For example, airplanes contain a number of doors of various types to equipment compartments and the like. A bolt that passes through an opening in the door and underlying structure and a nut that is fixedly mounted on the underlying structure are customarily used as locks for such doors. In airplane applications it is important that the doors be electrically impermeable and rigidly joined to the rest of the structure. Electrically impermeable doors require that the nut that is used must be sealed at one end to keep the bolt enclosed inside the nut; otherwise there is a risk that antenna effects will occur in the bolt.

An airplane contains a number of doors with underlying structures of various thicknesses, thereby necessitating the administration and stock-keeping of a large number of bolt lengths with associated nut components.

### DESCRIPTION OF THE INVENTION

One object of the present invention is to reduce the range of bolts needed. This has been achieved by means of a door lock for locking a door to an underlying structure, wherein a machine element disposed in connection to a through opening in the underlying structure is arranged so as to engage a bolt that is insertable into a through opening in the door. The door lock is characterized in that the machine element is inserted through the opening in the underlying structure to a position at which the openings in the door and the underlying structure form, together with the part of the machine element that protrudes outside of the underlying structure, a length that is longer than the bolt length. An internal thread realized in the machine element must simultaneously extend sufficiently far through the underlying structure that, with the joint mounted, it engages around the bolt to form the joint. The invention also comprises a method for manufacturing a door lock as per the foregoing.

Preferred embodiments possess one or more of the characterizing features described in the subordinate claims.

With the door lock and method according to the invention, only one bolt length is necessary for a large number of material thicknesses, with the administrative and financial advantages that this entails. Furthermore, the door lock obtained with the method according to the invention is well suited for use in aircraft applications, in that it can tolerate being opened and closed very large number times. The lock also transfers loads acting on the door and loads acting between the door and the rest of the structure.

### BRIEF DESCRIPTION OF FIGURES

FIG. 1 shows a section through an example of a bolt joint in an unmounted position.

FIG. 2 shows a section through the bolt joint in FIG. 1 in a mounted position.

FIG. 3 shows a section through a part of the bolt joint in FIG. 1.

FIG. 4 shows a cross-section along A-A in FIG. 1 according to a first embodiment.

FIG. 5 shows a cross-section along A-A in FIG. 1. according to a second embodiment.

### PREFERRED EMBODIMENTS

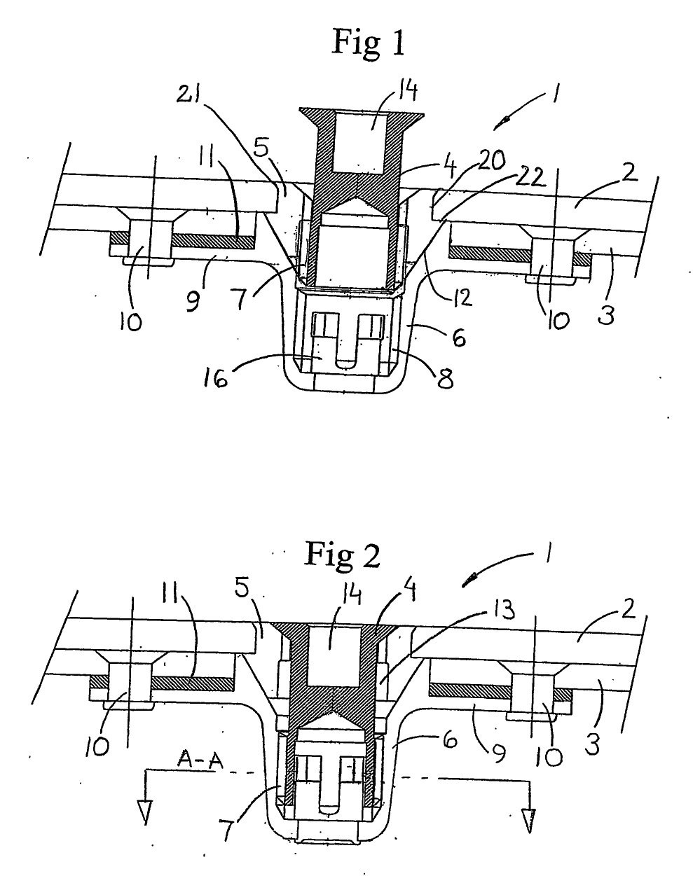

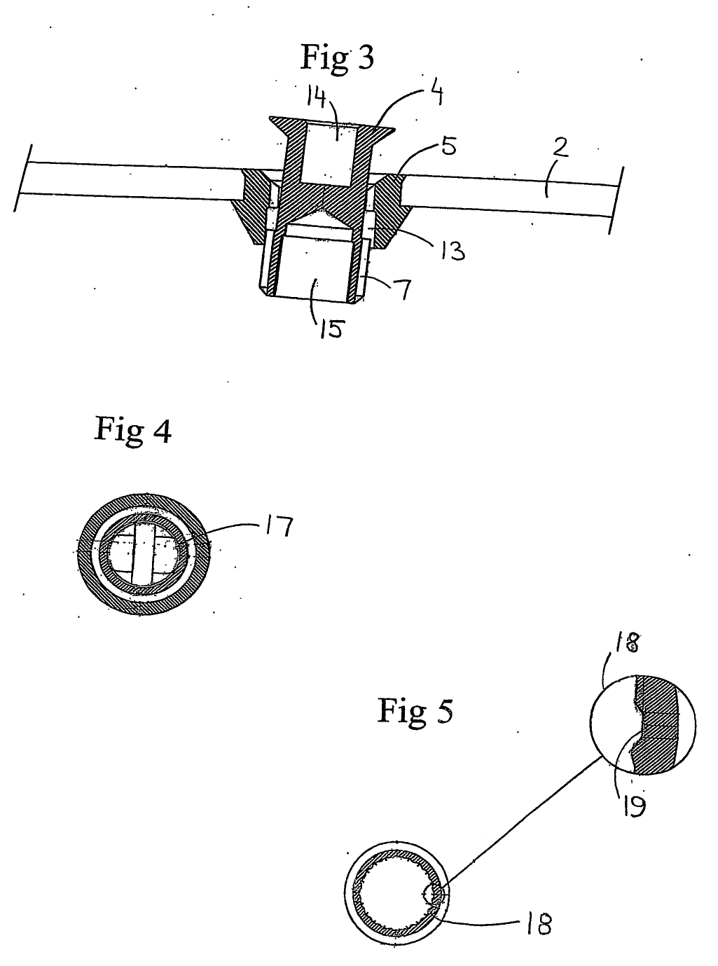

In FIGS. 1 and 2, reference number 1 designates a bolt joint that removably and fixedly secures a first structure 2 to a second structure 3. The bolt joint is disposed in a respective opening in the structures 2, 3. In the unrestricted example described below, the first structure 2 is a door and the second structure 3 is a doorframe, whereupon the bolt joint 1 is thus a door lock. The joint can conceivably be used as a door lock on, e.g. aircraft.

The bolt joint comprises a bolt 4, a bushing 5 and a machine element 6. The bushing 5 is disposed in the through opening in the door, and the machine element 6 is disposed in the through opening in the doorframe. The bolt 4 has a threaded part 7 and the machine element 6 has, internally, a thread 8 that complements said threaded part 7. The length of the bolt is chosen so as to enable its use on a door with a specified maximum thickness. On the other hand, it is inconsequential whether the bolt is shorter than the total thickness of the door and the door lock, as will be described below. In particular, the threaded part 7 need not extend in its entirety beyond the doorframe when the bolt is screwed all the way in.

The machine element 6 is partly introduced through the opening in the doorframe so that a first section of the machine element extends beyond the doorframe 3 and a second section of the machine element is disposed inside the doorframe. The first section comprises walls and a bottom, essentially enclosing the opening in the doorframe so that the doorframe surface with the first section of the machine element is essentially electrically impermeable. The second section is designed so as to essentially lie in abutment to the walls of the doorframe. A flange 9 realized in the machine element lies in abutment to the surface of the doorframe. The flange 9 functions as the boundary between the first and the second section, and ensures that the first section is not inserted into the opening in the doorframe 3. The machine element 6 in the example shown is mounted to the doorframe by means of rivets 10. The number of rivets 10 is, e.g. 2, 3 or 4. However, other methods of mounting the machine element to the doorframe 3 are conceivable, such as welding or gluing. An intermediate disk 11 is disposed between the flange 9 and the doorframe 3 in the example shown. The placement of the flange 9 on the machine element is chosen so that the machine element 6 is, on the one hand, not inserted into the doorframe further than would permit the entire bolt length to be screwed into the door, while simultaneously on the other hand, a sufficient large part of the machine element must be inserted into the doorframe so that, with the bolt fully inserted, the thread of the bolt and the thread of the machine element engage one another. When the bolt is fully inserted into the opening, a degree of play must exist between the bottom of the machine element and the bolt. The length of the bolt is thus constant, while the placement of the flange 9 on the machine element is determined by the thickness of the door and the doorframe. As a result, all the bolt joints in a unit, such as an airplane, can comprise bolts of a given, preselected bolt length.

The bushing in the example shown comprises a first section with a neck 20 and a flange part 21, 22 disposed on each side of the neck, where the length of the neck is determined by the door thickness, so that the flange parts 21, 22 lie in abutment to the shell surfaces of the door. A second section of the bushing extends from the door and into the opening in the doorframe when the joint is in its mounted position. The second sections of the bushing 5 and the machine element are moreover designed so that, in the mounted position, adjacent surfaces 12 lie in tight abutment to one another, i.e. the bushing 5 bottoms in the machine element 6. The bushing 5 is internally equipped with a thread 13 that complements that threading of the bolt so as, with the bolt joint unmounted, to hold the bolt 4 fixedly in the door by screwing it through the bolt and into the thread 13 realized in the bushing. There is thus no risk that the bolt 4 will be lost with the bolt joint unmounted.

A non-through axial notch 14 is realized at the head of the bolt 4. The notch 14 is intended to receive a tool, such as a screwdriver, in order to screw the bolt 4 into the machine element 6. An additional non-through axial notch 15 is realized at the opposite end of the bolt. In the example shown, a bifurcate recess 16 that extends into the machine element is disposed in the end of the machine element opposite the open end facing toward the bolt.

The notch 15 is designed to receive the bifurcate recess 16. The length of the bifurcate recess 16 is either less than or equal to the length of the corresponding notch 15, and designed to press against the lateral walls of the 15 along the entirety of its length or parts of its length with the bolt joint mounted, so as to hold the bolt in its position. In this way the bolt 4 avoids the risk of coming unscrewed from the machine element 6 if, e.g. the joint is subjected to strong vibrations; this is particularly important if the bolt is not properly screwed in. Designs other than those involving a bifurcate recess are also conceivable to realize the engagement between the bolt and the nut. It is however advantageous if the projecting part is threaded to some extent.

In FIG. 4, the engagement between the lateral walls of the notch 15 and the bifurcate recess 16 is realized solely by friction force. The engagement surfaces 17 are thus fiat. The engagement surfaces can be made of steel or another suitable material.

In FIG. 5 the surfaces that lie in abutment to one another in the notch 15 are designed so as to realize the engagement by means of a snap-in coupling. The engagement surfaces 18 in the notch 15 comprise a number of axially oriented indentations 19, and the recess has complementarily designed protrusions, whereupon the slot engages in the notch by “snapping” into the indentations.

A method for manufacturing the aforedescribed door lock entails that the bolt, which has a predetermined length, is provided for insertion into the through opening in the door, that the machine element arranged to engage the bolt is disposed in connection with the through opening of the doorframe in a position in which the openings in the door and the doorframe form, together with the part of the machine element that extends from the doorframe, a length that is longer than the bolt length, while at the same time the machine element extends sufficiently far through the doorframe that, with the joint mounted, it engages the bolt to form the joint.

1. A door lock for locking a door (2) to an underlying structure (3), wherein a machine element (6) disposed in connection to a through opening in the underlying structure (3) is arranged so as to engage a bolt (4) that is insertable in the through opening in the door (2), characterized in that the machine element (6) is inserted through the opening in the underlying structure (3) to a position at which the openings in the door (2) and the underlying structure (3) form, together with the part of the machine element (6) that extends outside of the underlying structure (6) [sic], a length that is longer than the bolt length, while at the same time an internal thread in the machine element extends sufficiently far through the underlying structure that, with the joint mounted, it engages the bolt to create the joint.

2. A door lock according to claim 1, characterized in that the machine element is externally provided with a radial flange that lies in abutment to the surface of the underlying structure.

3. A method for manufacturing a door lock that is intended to fixedly secure a door (2) to an underlying structure (3), wherein a machine element (6) arranged so as to engage a bolt (4) that is inserted into the through opening in the door (2) is disposed in connection to a through opening in the underlying structure (3), characterized in that, upon disposition, the machine element (6) is inserted through the opening in the underlying structure (3) to a position in which the openings in the door and the underlying structure form, together with the part of the machine element (6) that extends outside of the underlying structure, a length that is longer than the bolt length, while at the same time an internal thread in the machine element (6) extends sufficiently far through the underlying structure that, with the joint mounted, it engages the bolt to create the joint.

4. A method according to claim 3, characterized in that the machine element is externally equipped with a radial flange (9), which is brought into abutment to the surface of the underlying structure.

5. A method according to claim 4, characterized in that the placement of the flange (9) is chosen so that, with the door lock in its locked position, the head of the bolt (4) essentially bottoms in the door while at the same time a degree of play exists between the opposite end of the bolt and a bottom in the machine element.

6. A method according to claim 3, characterized in that there is mounted in the opening in the door (2) a bushing (5) that is internally equipped with a thread (13) that is complementarily designed with threading (7) in the bolt so as to fixedly hold the bolt (4) in the door (2) with the lock unlocked.

7. A method according to claim 6, characterized in that the bushing (5) is designed so that, with the lock locked, it forms an extension of the machine element (6).

8. A method according to any of the preceding claims, characterized in that a non-through notch (15) is realized in the bolt (4) in an end distal to the bolt head, and in that complementary means (16) are realized in the machine element (6), which complementary means, with the door lock locked, insert into the notch (15) to abut the lateral walls of the notch (15) so as to hold the bolt fixedly in place.

9. A method according to claim 8, characterized in that the complementary means (16) hold the bolt fixedly in place by means of a friction coupling.

10. A method according to claim 8, characterized in that the complementary means (16) hold the bolt fixedly in place by means of a snap-in coupling.

11. A method according to claim 1, characterized in that the machine element (6) is fixedly riveted into the underlying structure (3).

12. A machine element (6) manufactured in accordance with the method described in claim 3.

13. A door lock manufactured in accordance with the method described in claim 1.
